(19) United States
(12) Patent Application Publication
(10) Pub. No.: US 2019/0248555 A1
(43) Pub. Date: Aug. 15, 2019

(54) BIOMETRIC LOCKING CANNABIS/PILL CONTAINER

(71) Applicant: Steven D. Cabouli, San Diego, CA (US)

(72) Inventor: Steven D. Cabouli, San Diego, CA (US)

(21) Appl. No.: 15/893,617

(22) Filed: Feb. 10, 2018

(51) Int. Cl. B65D 55/14; G07C 9/00

(52) U.S. Cl. CPC B65D 55/14; G07C 9/00158

(57) ABSTRACT

This application relates to a unique design of Biometric Locking Cannabis/Pill Containers used in keeping substances secure and away from unauthorized access, including Cannabis and prescription drugs that may be harmful to adults or children if left unsecured in open or easily accessible containers. More particularly, the Biometric Locking Cannabis/Pill Containers system offers a secure locking device which employs the users biometric finger or thumb print for opening the container without the use of cumbersome keypads which codes can be forgotten or physical keys that can be easily misplaced or lost. The lids on the containers will be lithium-ion battery power operated and have open activation and battery indicator lights displaying green for sensor activation and red for low battery power along with optional vacuum pump fitting and on-board vacuum pumps operated by electrical power, on-board battery, or operated manually by push button.

### FIELD OF THE INVENTION

This application relates to a unique design of Biometric Locking Cannabis/Pill Containers used in keeping substances secure and away from unauthorized access, including Cannabis and prescription drugs that may be harmful to adults or children if left unsecured in open containers. More particularly, the Biometric Locking Cannabis/Pill Containers system offers a secure locking device which employs the users finger or thumb print for opening the container without the use of cumbersome keypads which codes can be forgotten or physical keys that can be easily misplaced or lost.

### BACKGROUND OF THE INVENTION

There is growing need to provide an adequate safe means to store substances in an air tight and safe environment such as Cannabis or pills that may be harmful to adults or children if left in open containers. The Biometric Locking system offers a new and unique finger or thumb means for opening the devices without the use of cumbersome keys that can be easily misplaced or lost. Cannabis and other drugs may be useful and legal to possess but can also be deadly for children and adults that are not responsible for their actions and should be handled with great caution.

In some circumstances, the tobacco-like articles may be stored in clear glass containers in a manner that permits excessive moisture migration into or out of the material. For example, moist Cannabis should not be stored in a manner that permits significant migration of moisture in and out of the container during both the product shelf life and the period of consumer use. Such moisture egress from the containers can cause the moist Cannabis to lose moisture and suffer a loss of freshness characteristics as well as negatively impact on desirable qualities of other tobacco like products.

Numerous innovations for containers have been provided in the prior art described as follows. Even though these innovations may be suitable for the specific individual purposes to which they address, they differ from the present Biometric Locking Cannabis/Pill Container as hereinafter contrasted. The following is a summary of those prior art patents most relevant to the Biometric Locking Cannabis/Pill Container at hand, as well as a description outlining the difference between the features of the present application and those of the prior art.

U.S. Pat. No. 8,556,070 of David Karl Bried et al. describes a tobacco product package device that can be used to enhance freshness and other characteristics of tobacco products or other products contained therein. Certain features can improve product freshness both during shelf life and during consumer use.

This patent describes a tobacco product package device that can be used to enhance freshness and other characteristics of tobacco products or other products contained therein but does not describe the unique Biometric Locking system using the finger or thumb unlocking means or anything similar to the Jar Biometric Locking Cannabis/Pill Container that will be made from a smoke tinted glass or a high-grade smoke tinted polymer.

U.S. Pat. No. 9,572,748 of Kevin Lim et al. describes a container that includes a chamber to hold a medication, a lockable lid that covers an opening of the chamber, a biometric sensor, a scale, and one or more processors. The container may store prescription information indicating how often the medication should be provided. The container may measure a weight of the medication held by the chamber using the scale. The container may receive biometric information sensed by the biometric sensor. The biometric information may indicate a biometric feature of a person attempting to open the container. The container may selectively unlock the lockable lid based on at least one of the prescription information, the weight of the medication, or the biometric information.

This patent describes a product package device for holding medications with a lockable lid that covers an opening of the chamber, a biometric sensor, a scale, and one or more processors. This patent deals with an involved service piece of equipment that requires a computer network to effectively work and does not describe a container for dispensing or hold pills or Cannibals or have the biometric finger or thumb locking means.

U.S. Pat. No. 9,630,747 of William Thomas Smith et al. describes a container for displaying, visualizing, and aroma sampling botanical materials-such as tea, cannabis, and the like including a container body, lid, and lens. The container body is shaped to define a mounting projection wherein a sample, such as a botanical sample, may be held. Container body and lid form an airtight seal. A sample may be visualized through the lens. In a preferred embodiment, lid is shaped to define scent openings permitting aroma sampling of a sample contained within. In one embodiment option, one or more projections secure a card bearing sample identification information.

This patent describes a container for displaying, visualizing, and aroma sampling botanical materials. This container would not offer the air tight seal and the biometric finger or thumb locking means on a compact or jar style of container.

US Patent Application Publication No. 2017/0190482 of William Thomas Smith et al. describes embodiment containers for displaying, visualizing, and aroma sampling botanical materials—such as tea, cannabis, and the like including a container body, lid, and lens—which may have various shapes. In a preferred embodiment, lid is shaped to define a recessed area with scent openings permitting aroma sampling of a sample contained within. A removable plug is shaped to fit within the recessed area of the lid. The container body and lid, with removable plug fit within the lid, form an airtight chamber within. A botanical sample may be visualized through the lens.

This patent describes a second container for displaying, visualizing, and aroma sampling of botanical materials such as tea and cannabis where a botanical sample may be visualized through the lens by readjusting the holding components of the device.

U.S. Pat. No. 9,869,978 of Mathew R. Gibertson et al. describes a method for commissioning a collection of electronic locks by inserting the same electronic key into each of the locks and recording in the electronic key an internal code unique to that lock which identifies the lock and is needed to open the lock and a method for biometrically permitting controlled secure access to a container having one of the commissioned electronic locks.

This patent describes a method for biometrically permitting controlled secure access to a container having one of the commissioned electronic locks. It does not describe the use of the Biometric Locking system using the finger or thumb unlocking means to unlock small or large containers holding cannabis or pills.

U.S. Pat. No. 9,355,510 of Rick Crigger et al. describes a biometric access control system includes an equipment structure in communication with an identification station, which includes a processor, a user biometric reader, an equipment identification reader, a user interface to display categories of equipment authorized for use by a user and to receive input from the user including an indication to acquire or return the piece of equipment and a selection of an equipment category and a selection of a specific piece of equipment of the selected equipment category. The equipment structure includes storage locations for storing pieces of equipment assigned to the storage locations, and locks corresponding to the storage locations for individually securing the pieces of equipment to the structure, wherein an authorization signal from the identification station is receivable to release a lock containing the selected specific piece of equipment to permit removal of the selected specific piece of equipment.

This patent describes a sophisticated weapon storage system using biometric components but does not use the Biometric Locking system using the finger or thumb unlocking means to unlock a pill or cannabis container.

US Patent Application Publication No. 2017/0046898 of Steven D. Cabouli describes a Biometric and Bluetooth enabled vehicle Console and Glove Box Lock that provides a unique apparatus for locking enclosures such as any locking compartment within a vehicle as well as the vehicle doors, vehicle hood and vehicle trunk locks, and the like, with indirect operational control by the means of a smartphone, tablet or a computer. The Biometric and Bluetooth enabled vehicle Console and Glove Box Lock contains a biometric based finger print authentication module, and a Bluetooth/RF COMM communication enabled module, to prevent a non-owner or unauthorized user from accessing the device.

This patent describes a Biometric and Bluetooth enabled vehicle Console and Glove Box Lock that provides a unique apparatus for locking enclosures such as any locking compartment within a vehicle but does not involve the process of Biometric locking containers used for Cannabis and Pills. It does not offer the unique feature of the ratchet configuration on a container engaging with the mating ratchet members on the Biometric locking mechanism of the Jar.

US Patent Application Publication No. 2016/0360351 of Steven D. Cabouli describes a Biometric and Bluetooth Enabled Case Lock System and method that provides a unique apparatus for locking enclosures such as luggage, briefcases, lockers, lock boxes and cabinets, and the like, with indirect operational control by the means of a smart phone, tablet or a computer. The Biometric and Bluetooth Enabled Case Lock system contains a biometric based finger print authentication module, and a Bluetooth communication enabled module, to prevent a non-owner or unauthorized user from accessing the device. An on-board system processor controls and interprets commands passed from the user's external Bluetooth device, whereby said case lock system is controllable via an application on a smartphone, tablet or a computer.

This patent describes a Biometric and Bluetooth Enabled Case Lock System that provides a unique apparatus for locking enclosures such as luggage, briefcases, lockers, lock boxes and cabinets but does not offer a safe, air tight containers using a unique style of Biometric locking mechanism in the storage of Pills or Cannabis.

None of the foregoing prior art teaches or suggests the particular unique features of the Biometric Locking Cannabis/Pill Containers and thus clarifies the need for further improvements in the devices that can be used for these purposes.

In this respect, before explaining at least one embodiment of the Biometric Locking Cannabis/Pill Containers in detail it is to be understood that the design is not limited in its application to the details of construction and to the arrangement of the components set forth in the following description or illustrated in the drawings. The Biometric Locking Cannabis/Pill Containers are capable of other embodiments and of being practiced and carried out in various ways. Also, it is to be understood that the phraseology and terminology employed herein are for the purpose of description and should not be regarded as limiting.

### SUMMARY OF THE INVENTION

The advantage of the Biometric Locking Cannabis/Pill Containers is to provide an adequate safe means to store substances in a tight environment, such as Cannabis or pills that may be harmful to adults or children if left in open unsecured containers.

Another advantage of the Biometric Locking Cannabis/Pill Containers is that they are locked by the means of unique Biometric Locking device operated only by the finger or thumb activation means.

Another advantage of the Biometric Locking Cannabis/Pill Containers is the battery indicator lights displaying green for sensor activation and red for low battery power along with the fact that the units will remain open when the battery has run out of power.

Another advantage of the Biometric Locking Cannabis/Pill Containers is that by holding the products in a sealed air tight environment it will extend their useable life span.

The advantage of the preferred embodiment of the Compact Biometric Locking Cannabis/Pill Container is its small size and air tight sealing capability.

Another advantage of the preferred embodiment of the Compact Biometric Locking Cannabis/Pill Container is that they will have several different interchangeable product organization and containment means.

The advantage of the alternate embodiment of the Jar Biometric Locking Cannabis/Pill Container is that it is a size that can hold larger quantities of substances within an air tight sealing and locked environment.

Another advantage of the alternate embodiment of the Jar Biometric Locking Cannabis/Pill Container is it can have several different internal styles of holding cavities.

Another advantage of the alternate embodiment of the Jar Biometric Locking Cannabis/Pill Container is it can come with a rotatable disk on a shoulder screw with an opening to separately isolate each of the holding cavities.

Another advantage of the alternate embodiment of the Jar Biometric Locking Cannabis/Pill Container is it will have a threaded lid that will rotate down to tighten against an O-ring sealing means.

Another advantage of the alternate embodiment of the Jar Biometric Locking Cannabis/Pill Container is it will only need a ninety to one hundred and eighty degree turn to tighten the lid against the O-ring seal.

Another advantage of the alternate embodiment of the Jar Biometric Locking Cannabis/Pill Container is it will have the Biometric Locking mechanism on the underside of the lid with two ratchet or gear style engaging arms that have the capability of securely locating at any two locations on the ratchet or gear configuration above the threads on the upper edge surface of the Jar.

Another advantage of the alternate embodiment of the Jar Biometric Locking Cannabis/Pill Container is it will make the ratcheting sound when rotating the lid down and the ratchet locking member will be retracted by the means of the unique Biometric Locking device operated only by a finger or thumb activation means.

Another advantage of the alternate embodiment of the Jar Biometric Locking Cannabis/Pill Container is the jar will preferably be made from a smoke tinted tempered glass but could be made from a high-grade smoke tinted polymer and still remain within the scope of this application.

Another advantage of the alternate embodiment of the Jar Biometric Locking Cannabis/Pill Container is that it can be manufactured in a variety of different sizes from small personal sizes up to very large sizes to be used in stores that sell products like Cannabis that need a secure easy opening and sealing means of storage where a sales person only needs to put their thumb or finger on the Biometric Lock to unlock lid and turn the lid ninety to one hundred and eighty degrees to open the Jar and then replace and relock the lid after the sale is completed.

These together with other advantages of the Biometric Locking Cannabis/Pill Containers, along with the various features of novelty, which characterize the design are pointed out with particularity in the claims annexed to and forming a part of this disclosure. For a better understanding of the Biometric Locking Cannabis/Pill Containers, their operating advantages and the specific objects attained by its uses, reference should be made to the accompanying drawings and descriptive matter in which there are illustrated preferred embodiments of the Biometric Locking Cannabis/Pill Containers. There has thus been outlined, rather broadly, the more important features of the design in order that the detailed description thereof that follows may be better understood, and in order that the present contribution to the art may be better appreciated. There are additional features of the Biometric Locking Cannabis/Pill Containers that will be described hereinafter, and which will form the subject matter of the claims appended hereto.

The preferred embodiment of the Compact Biometric Locking Cannabis/Pill Container will consist of a top lid containing the Biometric Locking mechanism operated by the means of the finger or thumb activation means and a locking bar. The top lid is hinged to bottom portion having a variety of different storage means and will snap into the locked position when closed. The Container will have battery indicator LED lights displaying a green LED light for sensor activation and red LED light for low battery power along with the fact that the unit will remain open when the battery has run out of power. This will insure that Compact Biometric Locking Cannabis/Pill Container will not be locked shut with a dead battery. The locking bar of the Biometric Locking mechanism will engage in the mating locking tabs at the open end of the bottom portion. One internal storage means will be for sealed or unsealed tubes of material like Cigar's or Cannabis. Another option will have a variety of cavities with separate lids similar to conventional pill storage containers.

The alternate embodiment of the Jar Biometric Locking Cannabis/Pill Container will consist of a smoked tempered glass or a high-grade smoke tinted polymer. This dark tinted jar will provide UV protection for the contents. The upper edge surface of the Jar will have a ratchet or gear style of locking surface which will engage with a mating surface on the locking arms of the Biometric locking mechanism located on the underside of the lid. The Containers will have battery indicator LED lights displaying green for sensor activation and red for low battery power along with the fact that the unit will remain open when the battery has run out of power to ensure that it cannot be locked shut with a dead battery. The lid will screw down on the Jar against an O-ring seal by turning the handle ninety to one hundred and eighty degrees making a ratcheting sound. The O-ring will provide a water-resistant seal and the resulting container will be air tight, water tight, smell-proof in either the case or the jar configuration.

The Jar can have varying organizational inserts dividing the central area into different cavities that may optionally have a rotatable disk on a shoulder screw with an opening to separately isolate each of the holding cavities. It can be manufactured in a variety of different sizes from small personal sizes up to very large sizes to be used in stores that sell products that need to be kept in a locked controlled environment.

With respect to the above description then, it is to be realized that the optimum dimensional relationships for the parts of the Biometric Locking Cannabis/Pill Containers, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present design. Therefore, the foregoing is considered as illustrative only of the principles of the Biometric Locking Cannabis/Pill Containers. Further, since numerous modifications and changes will readily occur to those skilled in the art, it is not desired to limit the Biometric Locking Cannabis/Pill Containers to the exact construction and operation shown and described, and accordingly, all suitable modifications and equivalents may be resorted to, falling within the scope of this application.

### BRIEF DESCRIPTION OF THE DRAWINGS

The accompanying drawings, which are incorporated in and form a part of this specification, illustrate embodiments of the Biometric Locking Cannabis/Pill Containers and together with the description, serve to explain the principles of this application.

FIG. 1 depicts a Compact Biometric Locking Cannabis/Pill Container in the closed position with the biometric finger or thumb print activation opening mechanism on the top surface.

FIG. 2 depicts a Compact Biometric Locking Cannabis/Pill Container in the open position with the tubular storage means and the Biometric Locking mechanism exposed.

FIG. 3 depicts a Compact Biometric Locking Cannabis/Pill Container in the open position with a pill organization and storage area in the bottom portion.

FIG. 4 depicts the alternate embodiment of the Jar Biometric Locking Cannabis/Pill Container with organizational inserts dividing the central area into different organization cavities and the lid exploded away.

FIG. 5 depicts the alternate embodiment of the Jar Biometric Locking Cannabis/Pill Container with organizational inserts dividing the central area into different organization cavities with a rotatable disk, a shoulder screw and an opening to separately isolate each of the holding cavities.

FIG. 6 depicts the lid exposing the underside of the Jar Biometric Locking Cannabis/Pill Container.

FIG. 7 depicts an open Jar Biometric Locking Cannabis/Pill Container exposing sealed tubular cylinders.

FIG. 8 depicts an open Jar Biometric Locking Cannabis/Pill Container with open tubular cylinders.

FIG. 9 depicts the underside of the Biometric Locking mechanism.

FIG. 10 depicts the ratchet style of the locking mechanism.

FIG. 11 depicts the gear style of the locking mechanism.

FIG. 12 depicts a large Jar Biometric Locking Cannabis/Pill Container having a screw on lid with the handle and finger or thumb activation means.

FIG. 13 depicts a large Jar Biometric Locking Cannabis/Pill Container having a screw on lid with the handle and finger or thumb activation means, illustrating a vacuum pump connection fitting mounted on the top of the lid.

FIG. 14 depicts a large Jar Biometric Locking Cannabis/Pill Container having a screw on lid with the handle and finger or thumb activation means, illustrating an electrically operated vacuum pump mounted within the lid.

FIG. 15 depicts a large Jar Biometric Locking Cannabis/Pill Container having a screw on lid with the handle and finger or thumb activation means, illustrating a manually operated vacuum pump mounted within the lid.

### DETAILED DESCRIPTION OF THE PREFERRED EMBODIMENTS

As required, the detailed embodiments of the present Biometric Locking Cannabis/Pill Containers 10A, 10B, and 10C are disclosed herein, however, it is to be understood that the disclosed embodiments are merely exemplary of the design that may be embodied in various forms. Therefore, specific functional and structural details disclosed herein are not to be interpreted as limiting, but merely as basic for the claims and as a representative basis for teaching one skilled in the art to variously employ the present design in virtually any appropriately detailed structure.

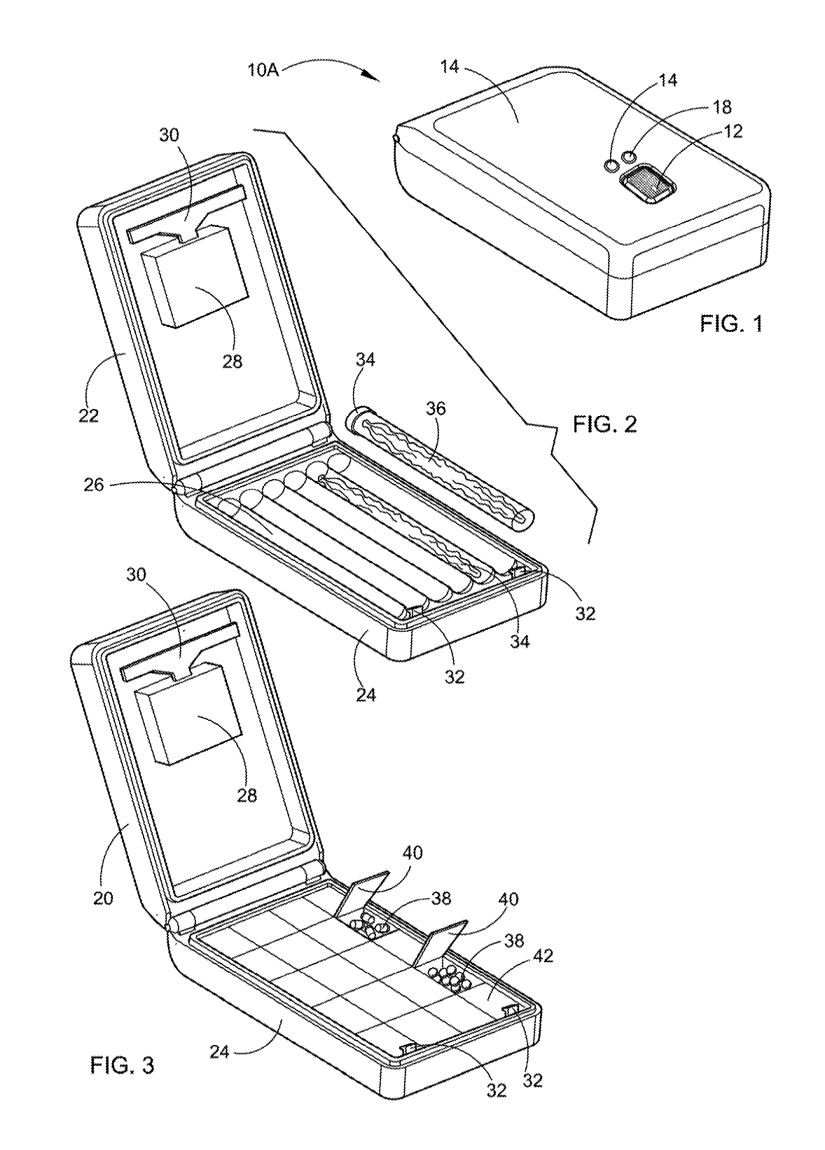

FIG. 1 depicts a Compact Biometric Locking Cannabis/Pill Container 10A in the closed position with the biometric finger or thumb print activation opening mechanism 12 on the container top surface 14. Adjacent to the activation mechanism 12 is a red LED light 16 indicating low battery power and a green LED light 18 displaying opening activation. A rubber seal 20 runs around the perimeter of both the container top 22 and the container bottom 24 to create the air tight seal. This compact configuration resembles a wallet and can be easily carried in a user's pocket keeping the contents safe from unauthorized access. These containers can vary in size from the convenient pocket size to larger display sizes and still remain within the scope of this application.

FIG. 2 depicts a Compact Biometric Locking Cannabis/Pill Container 10A with the container top 22 in the open position exposing the tubular storage means 26 and the Biometric Locking mechanism 28. The locking bar 30 on the Biometric Locking mechanism 28 will automatically engage within the locking tabs 32 on the front edge of the container bottom 24 when the device is closed. A sealed tubular container 34 containing Cannabis 36 is exploded away.

FIG. 3 depicts a Compact Biometric Locking Cannabis/Pill Container 10A in the open position with the Biometric Locking mechanism 28 in the container top 22 and the pill storage area 38 with compartment lids 40 on each compartment 42 in the container bottom 24.

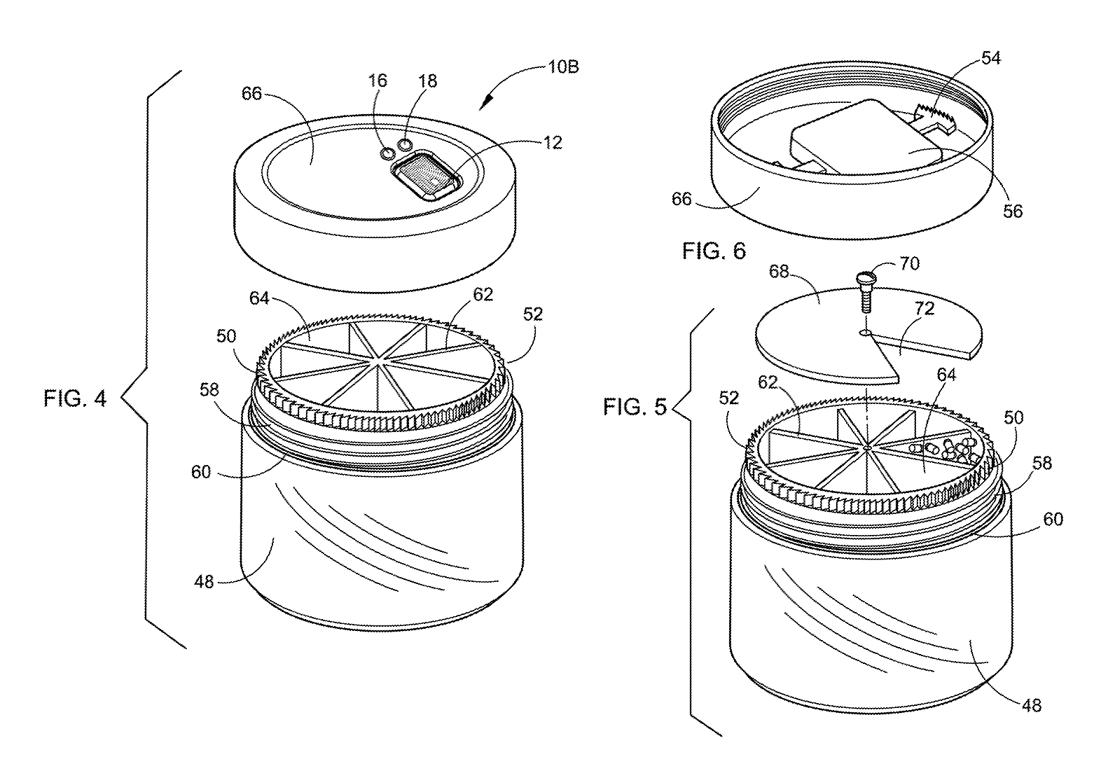

FIG. 4 depicts the alternate embodiment of the Jar Biometric Locking Cannabis/Pill Container 10B consisting of a smoked glass or possibly high-grade smoke polymer container 48. The Jar Biometric Locking Cannabis/Pill Container 10B will have a ratchet or gear style of locking surface 50 on the upper edge surface 52 which will engage with a mating surface on the locking arms 54 of the Biometric locking mechanism 56 located on the underside of the lid. Threads 58 and an O-ring 60 will be below the ratchet or gear style of locking surface 50. An insert 62 can be used to divide the central area into different cavities 64. The Jar lid 66 will have the finger or thumb unlocking means 12 with the red LED light 16 indicating low battery power and a green LED light 18 displaying sensor activation.

FIG. 5 depicts the alternate embodiment of the Jar Biometric Locking Cannabis/Pill Container 10B with inserts 62 dividing the central area into different cavities 64 with rotatable disk 68 on a shoulder screw 70 with an opening 72 to separately isolate each of the holding cavities 64.

FIG. 6 depicts the underside of the Jar Biometric Locking Cannabis/Pill Container Jar 10B lid 66, illustrating the location of one of the Biometric Locking arms of 54.

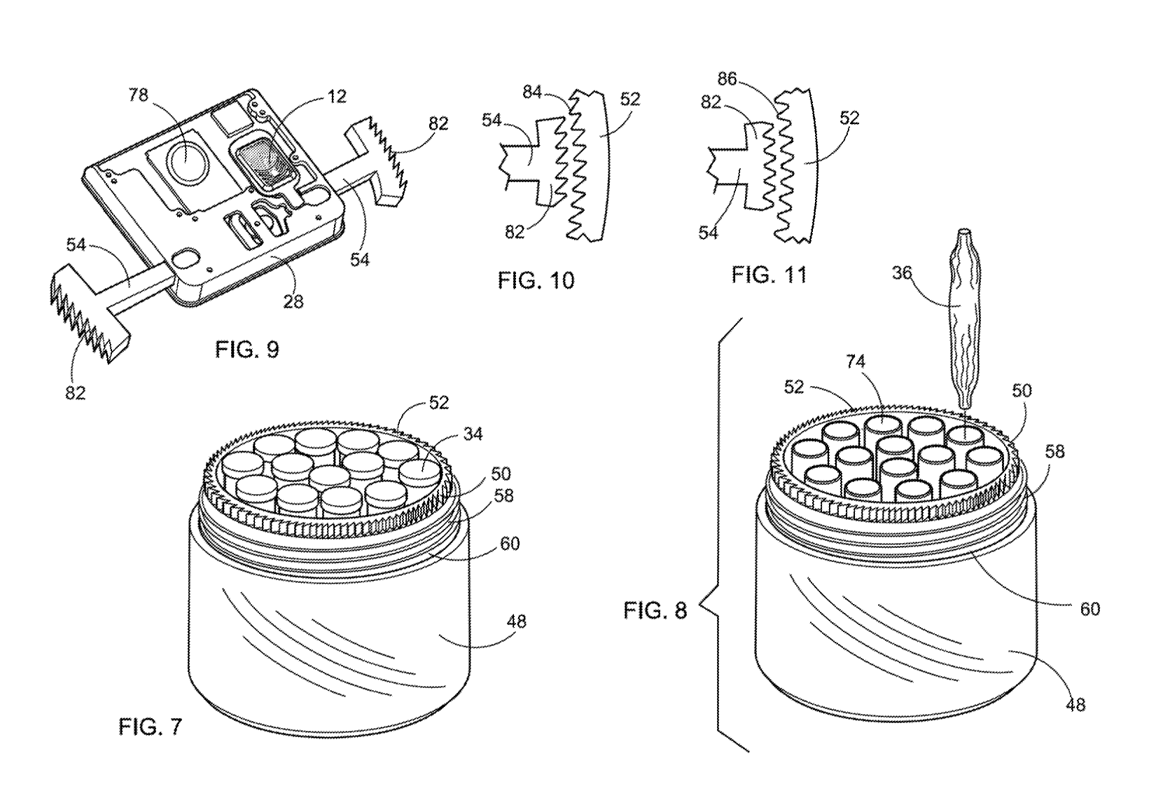

FIG. 7 depicts an open Jar Biometric Locking Cannabis/Pill Container 108 exposing sealed tubular cylinders 34 with a portion of Cannabis 36 exploded away.

FIG. 8 depicts an open Jar Biometric Locking Cannabis/Pill Container 108 with open tubular cylinders 74.

FIG. 9 depicts the underside of the Biometric Locking mechanism 28 illustrating the finger and thumb activation sensor 12, the battery 78 and the locking arms 54. At the end of each of the locking arms 54 are the locking heads 82 that will engage in the unique style of locking upper edge surface 52 of the smoked glass or high-grade smoke polymer container 48.

FIG. 10 depicts the ratchet style of locking mechanism with a ratchet configuration 84 on the locking head 82 of the Biometric Locking mechanism 28 and a mating style of the ratchet configuration 84 on the Jar upper edge surface 52.

FIG. 11 depicts the gear style of locking mechanism with a common gear configuration 84 on the locking heads of the Biometric Locking mechanism 28 and a mating style of the common gear configuration 86 on the Jar upper edge surface 52.

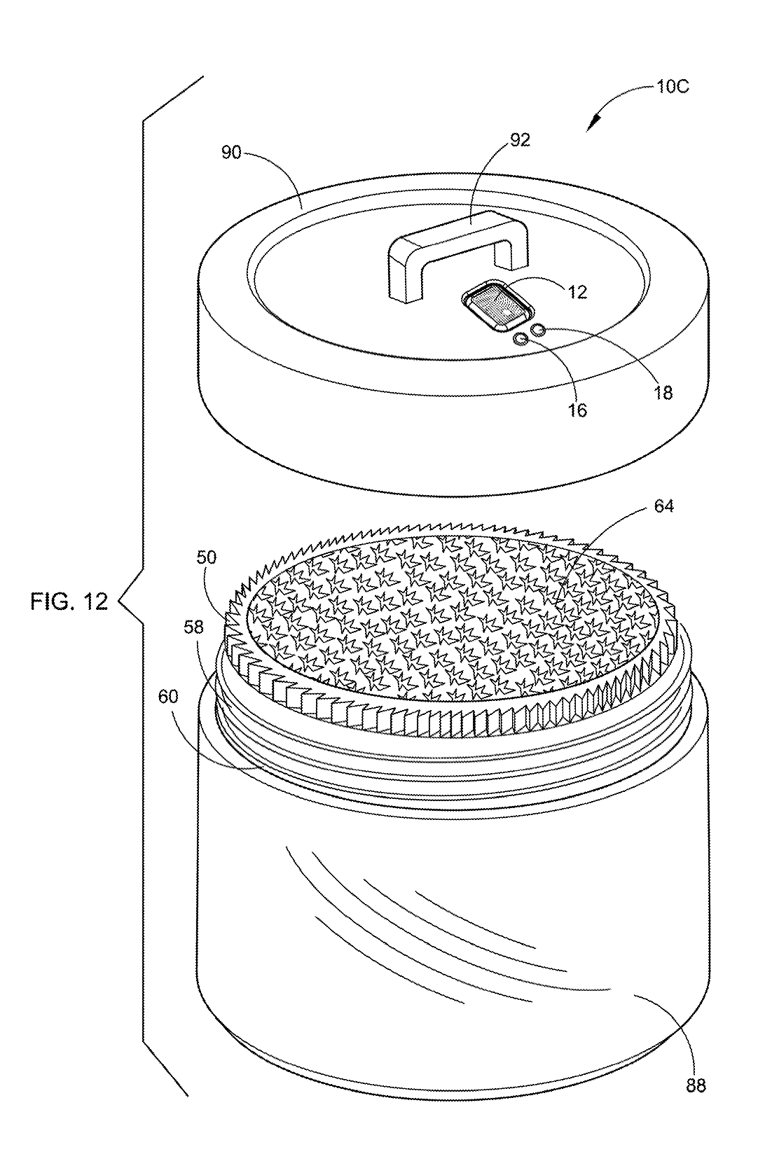

FIG. 12 depicts a large Jar Biometric Locking Cannabis/Pill Container 10C consisting of a smoked glass or possibly high-grade smoke polymer 88 having the screw on lid 90 with the handle 92 and finger or thumb activation means 12 filled with Cannabis 64. The large Jar lid 66 will have the activation finger or thumb locking means 12 with the red LED light 16 indicating low battery power and a green LED light 18 displaying sensor activation. It is anticipated that many sizes of jars may be employed, including small, medium size and large to very large containers, all equipped with a biometric locking mechanism within the lid assembly.

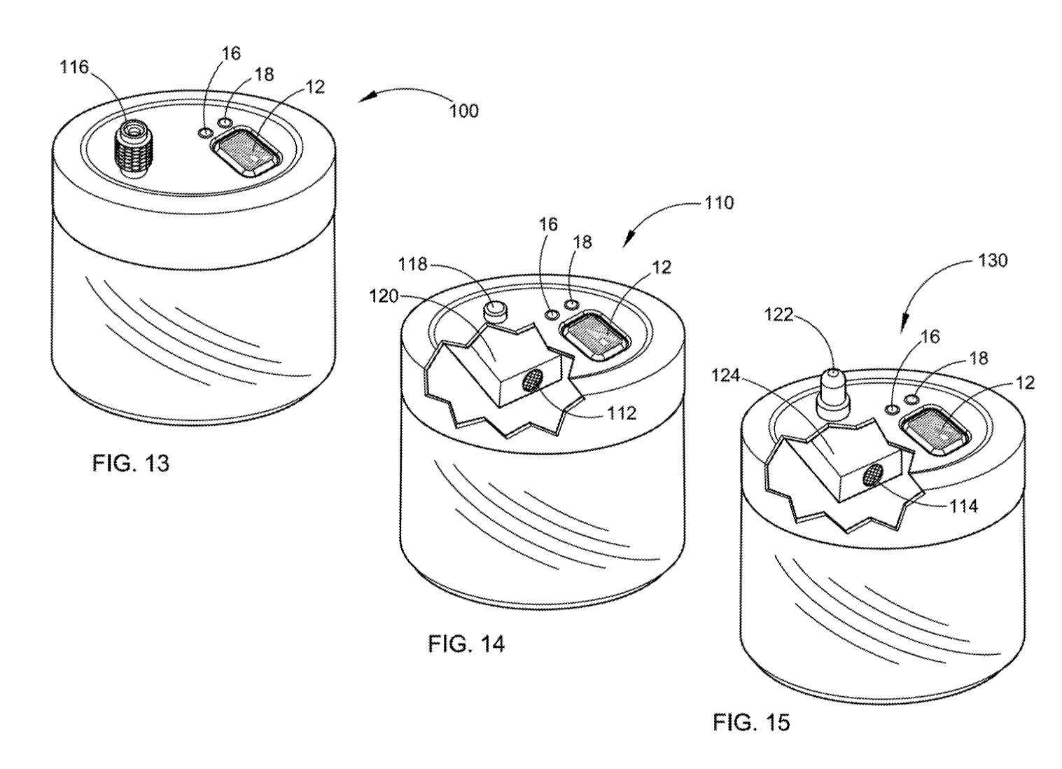

FIG. 13 depicts a large Jar Biometric Locking Cannabis/Pill Container having a screw on lid 100 with the finger or thumb print activation means, illustrating a vacuum pump connection fitting 116 mounted on the top of the lid. To create a vacuum inside the Biometric Locking Cannabis/Pill Container 100 the vacuum pump connection fitting 116 would be connected to a hose running from a vacuum pump, then the pump turned on and vacuum inside the container would result. In this way, numerous containers could be connected in series and a vacuum created in each, or they could be connected on at a time to create a vacuum within the several containers

FIG. 14 depicts a large Jar Biometric Locking Cannabis/Pill Container having a screw on lid 110 with the finger or thumb biometric activation means, illustrating an electrically operated vacuum pump 120 mounted within the lid. This electrically operated vacuum pump 120 would be turned on and off using the on/off button switch 118. When the electrically operated vacuum pump 120 is turned on it would pull a vacuum from the container through screen 112 which would keep particles from entering the electrically operated vacuum pump 120. This electrically operated pump could be powered by the biometric locking mechanism battery or have its own on-board battery for a power source. It is anticipated that lithium-ion batteries would be employed.

FIG. 15 depicts a large Jar Biometric Locking Cannabis/Pill Container having a screw on lid 130 with the biometric finger or thumb print activation means, illustrating a manually operated vacuum pump 124 mounted within the lid. The manually operated vacuum pump 124 is operated by pumping up and down on the pump button 122. This pumping action creates a vacuum within the container. As the pumping action of button 122 continued, a vacuum would be pulled within the container through screen 114 which would keep particles from entering the electrically operated vacuum pump 124.

The Biometric Locking Cannabis/Pill Containers 10A, 10B and 10C shown in the drawings and described in detail herein disclose arrangements of elements of particular construction and configuration for illustrating preferred embodiments of structure and method of operation of the present design. It is to be understood, however, that elements of different construction and configuration and other arrangements thereof, other than those illustrated and described may be employed for providing a Biometric Locking Cannabis/Pill Containers 10A, 10B and 10C in accordance with the spirit of this application, and such changes, alternations and modifications as would occur to those skilled in the art are considered to be within the scope of this application as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the Biometric Locking Cannabis/Pill Containers in any way.

1. A biometric locking cannabis and pill container comprising:
(a) a housing having a container storage compartment, including an upper edge surface having a plurality of integral locking teeth, and an openable lockable container lid;
(b) a biometrically actuatable locking mechanism mounted on said openable lockable lid having one or more movable locking arms having one or more locking heads capable of mating with said plurality of integral locking teeth; and
(c) a biometric fingerprint sensor in electronic communication with said locking mechanism mounted on said openable lockable lid, which when activated by a user's fingerprint, actuates said locking mechanism to open said openable lockable container lid;
wherein when said openable lockable container lid is closed said biometrically actuatable locking mechanism locks by mating said plurality of integral locking teeth with said one or more movable locking arms and said container lid is opened by activating said biometrically actuatable locking mechanism mounted on said openable lockable lid employing said biometric fingerprint sensor in electronic communication with said locking mechanism.

2. The biometric locking cannabis and pill container according to claim 1, wherein said housing having a container storage compartment and said openable lockable container lid assembly is a one-piece rectangular wallet shaped unit with said lid connected to said storage compartment with a hinge.

3. The biometric locking cannabis and pill container according to claim 1, wherein said housing having a container storage compartment and said openable lockable container lid assembly is a two-piece round jar shaped unit with said lid completely removable from said storage compartment.

4. The biometric locking cannabis and pill container according to claim 1, wherein said biometrically actuatable locking mechanism mounted on said openable lockable lid having one or more movable locking bars includes an electronic lithium-ion battery powered actuator for moving said locking bars.

5. The biometric locking cannabis and pill container according to claim 3, wherein said round jar shaped unit storage compartment includes a plurality of locking teeth internally on the entire circumference of the upper edge of the jar compartment piece.

6. The biometric locking cannabis and pill container according to claim 1, wherein said biometric fingerprint sensor in electronic communication with said locking mechanism mounted on said openable lockable lid further includes an open activation LED indicator and a battery power LED indicator.

7. The biometric locking cannabis and pill container according to claim 1, wherein said housing having a container storage compartment further includes organizational inserts for the purpose of organizing said container storage compartment contents.

8. The biometric locking cannabis and pill container according to claim 1, wherein said openable lockable container lid further includes a vacuum pump hose connection fitting.

9. The biometric locking cannabis and pill container according to claim 1, wherein said openable lockable container lid further includes an electronically operated vacuum pump.

10. The biometric locking cannabis and pill container according to claim 1, wherein said openable lockable container lid further includes a manually operated vacuum pump.

11. A method for making a biometric locking cannabis and pill container comprising the steps of:
(a) providing a housing having a container storage compartment, including an upper edge surface having a plurality of integral locking teeth, and an openable lockable container lid;
(b) providing a biometrically actuatable locking mechanism mounted on said openable lockable lid having one or more movable locking arms having one or more locking heads capable of mating with said plurality of integral locking teeth; and
(c) providing a biometric fingerprint sensor in electronic communication with said locking mechanism mounted on said openable lockable lid, which when activated by a user's fingerprint, actuates said locking mechanism to open said openable lockable container lid;
wherein when said openable lockable container lid is closed said biometrically actuatable locking mechanism locks by mating said plurality of integral locking teeth with said one or more movable locking arms and said container lid is opened by activating said biometrically actuatable locking mechanism mounted on said openable lockable lid employing said biometric fingerprint sensor in electronic communication with said locking mechanism.

12. The method of making a biometric locking cannabis and pill container according to claim 11, wherein said housing having a container storage compartment and said openable lockable container lid assembly is a one-piece rectangular wallet shaped unit with said lid connected to said storage compartment with a hinge.

13. The method of making a biometric locking cannabis and pill container according to claim 11, wherein said housing having a container storage compartment and said openable lockable container lid assembly is a two-piece round jar shaped unit with said lid completely removable from said storage compartment.

14. The method of making a biometric locking cannabis and pill container according to claim 11, wherein said biometrically actuatable locking mechanism mounted on said openable lockable lid having one or more movable locking bars includes an electronic lithium-ion battery powered actuator for moving said locking bars.

15. The method of making a biometric locking cannabis and pill container according to claim 13, wherein said round jar shaped unit storage compartment includes a plurality of locking teeth internally on the entire circumference of the upper edge of the jar compartment piece.

16. The method of making a biometric locking cannabis and pill container according to claim 11, wherein said biometric fingerprint sensor in electronic communication with said locking mechanism mounted on said openable lockable lid further includes an open activation LED indicator and a battery power LED indicator.

17. The method of making a biometric locking cannabis and pill container according to claim 11, wherein said housing having a container storage compartment further includes organizational inserts for the purpose of organizing said container storage compartment contents.

18. The method of making a biometric locking cannabis and pill container according to claim 11, wherein said openable lockable container lid further includes a vacuum pump hose connection fitting.

19. The method of making a biometric locking cannabis and pill container according to claim 11, wherein said openable lockable container lid further includes an electronically operated vacuum pump.

20. The method of making a biometric locking cannabis and pill container according to claim 11, wherein said openable lockable container lid further includes a manually operated vacuum pump.
